(19) United States
(12) Patent Application Publication
(10) Pub. No.: US 2015/0182988 A1
(43) Pub. Date: Jul. 2, 2015

(54) Construction Plug and Method of Use

(71) Applicants: Gary S. Wills, Stockton, CA (US); Mark Steininger, Queensbury, NY (US)

(72) Inventors: Gary S. Wills, Stockton, CA (US); Mark Steininger, Queensbury, NY (US)

(21) Appl. No.: 14/583,685

(22) Filed: Dec. 27, 2014

Related U.S. Application Data
(60) Provisional application No. 61/922,777, filed on Dec. 31, 2013.

(51) Int. Cl. B05C 21/00

(52) U.S. Cl. CPC B05C 21/005

(57) ABSTRACT

A Gripstay channel plug for use in covering a lumen contained in a Gripstay channel during the application of SFRM as part of the construction of steel-frame buildings, the plug comprising a face side, a top side, a bottom side, a left side. a right side and a first end that is affixed to a second end through a midsection such that the plug substantially covers the lumen to substantially prevent the SFRM from entering the lumen.

### CROSS-REFERENCE TO RELATED APPLICATIONS

This application claims the benefit of U.S. patent application Ser. No. 61/922,777, filed in the US Patent and Trademark Office on 31 Dec. 2013.

### BACKGROUND OF THE INVENTION

1. Field of the Invention

This invention lies within the field encompassing the construction of steel-beam buildings, specifically within the field encompassing the prevention of the uncontrolled spread of fire-retardant foam when on the beams of steel-beam buildings.

2. Description Of Related Art

U.S. Pat. No. 5,063,722 teaches “A gripstay channel veneer anchor assembly includes a channel member which abuttingly engages an insulation layer which in turn abuttingly engages a plurality of support members which form the inner wythe of an edifice. A clip securement menber projects through apertures in the channel member, pierces the insulation member and abuttingly engages the support member. A mounting screw is provided which connects the clip securement member, the channel member and the support member to form a rigid and reliable structure.” The Gripstay, used primarily in steel-building construction, is welded to the steel I-beam and has a slot in which construction workers can attach various anchors or accessories that are used to complete construction work on the building. Individual Gripstays are welded at 16-inch intervals along each I-beam in a building.

Spray Fire Resistant Material (“SFRM”) is required to be used in all steel construction. However, SFRM clogs the slot in each Gripstay. SFRM is sprayed onto an I-beam in a continuous coat after the Gripstay has been tack-welded to the I-beam. The slot of the Gripstay is thereby plugged with SFRM, which a construction crew member must manually remove from the Gripstay at great time, labor and financial cost.

U.S. Pat. No. 5,968,615 teaches “ . . . a seal of flexible/compressible polymer and a surface coating made of a material which is incombustible and/or maintains its integrity at high temperature. The seals are useful in the construction of fire-resistant structures.”

U.S. Pat. No. 6,428,017 teaches “A plug, for use in sealing the ends of a drive shaft the ends of which have been reduced in diameter, has an annular skirt coupled by a conical web to a central core, the web and the skirt being elastically deformable thereby enabling the plug to collapse radially inwardly as the plug is drawn through the reduced diameter end of the shaft.”

U.S. Pat. No. 7,854,096 teaches “Embodiments of door protectors are described. One typical embodiment comprises front and rear corrugated cardboard panels that are draped over a door by way of one or more pieces of saddle tape that join the panels along their respective top edges. A plurality of folds, perforations and cutouts are provided on the faces of the panels to permit access to the door's hardware. Accordingly, the door can be operated in a traditional manner while providing impact and damage protection to the door. The panels include a plurality of widthwise folds that permit the door protector to be folded for transport and storage. In variations, the edge straps are provided often comprised of hook and loop material to both secure the protector in a folded configuration and to an associated door.”

While plugs and seals that prevent the passage of a substance from one place to another are well known in the art, there is a long-felt but unmet need for a means to prevent the spread of SFRMs into the lumen of a Gripstay channel during the process of constructing a steel-beam building.

### BRIEF DESCRIPTION OF THE DRAWINGS

FIG. 1 shows an overview of a Gripstay channel plug 100 to be inserted in a Gripstay channel lumen 120 prior to applying SFRM 160 to a steel beam 180.

FIG. 2 shows a Gripstay channel lumen 120 with two ends, a first end 210 and a second end 220, each end 210/220 being narrower than a central portion 230. FIG. 3 shows a Gripstay channel plug 100 with two ends, a first end 310 and a second end 320, each end 310/320 being narrower than a central portion 330.

FIG. 4a shows a Gripstay channel plug 100 with two ends 310/320 slidingly affixed to one another.

FIG. 4b shows a Gripstay channel plug 100 with two ends 310/320 snappingly affixed to one another.

FIG. 4c shows a Gripstay channel plug 100 with two ends 310/320 immovably affixed to one another.

FIG. 4d shows a Gripstay channel plug 100 with two ends 310/320 springingly affixed to one another.

FIG. 4e shows a Gripstay channel plug with two ends 310/320 ratchetingly affixed to one another.

FIG. 5 shows an exploded view of a Gripstay channel plug 100.

FIG. 6 shows a Gripstay channel 140 with a Gripstay channel plug 100 inserted.

### DETAILED DESCRIPTION OF THE INVENTION

The present invention comprises a shield or plug 100 used to protect the lumen 120 of an existing product called a “Gripstay,” described in U.S. Pat. No. 5,063,722, from being clogged by SFRM 160 when said SFRM 160 is sprayed onto a steel I-beam 180 during the construction of a steel-frame building (not pictured).

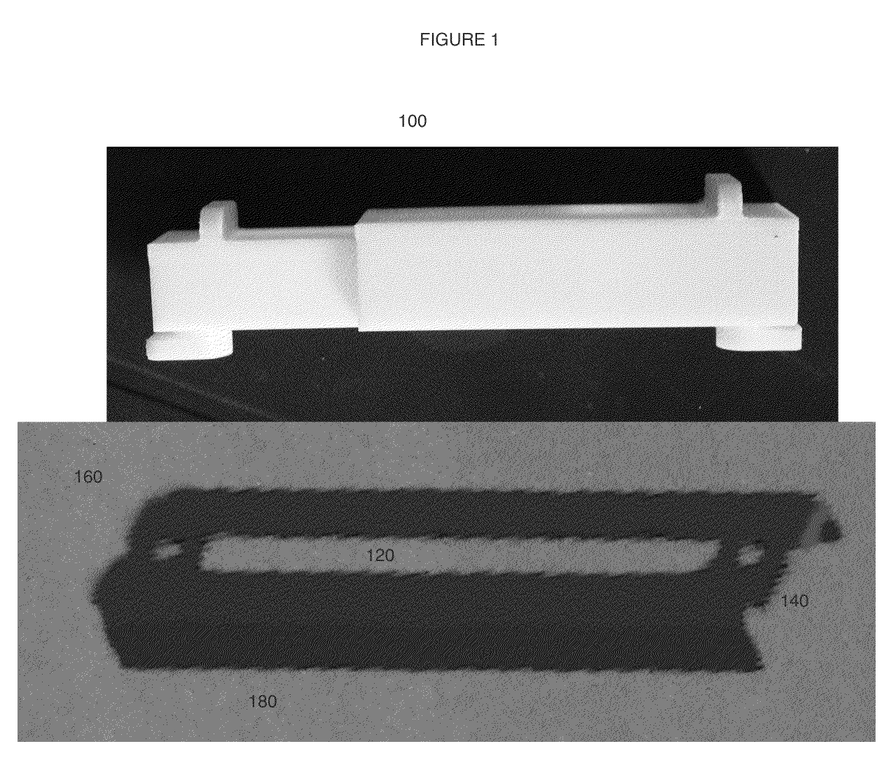

Referring now to FIG. 1, an overview of a Gripstay channel plug 100 to be inserted in a Gripstay channel lumen 120 of a Gripstay channel 140 prior to applying SFRM 160 to a steel beam 180 is shown. The Gripstay channel plug 100 is of sufficient size to substantially cover the Gripstay channel lumen 120 of the Gripstay channel 140. The Gripstay channel plug 100 is molded into a “C” shape in the present embodiment, but may be molded into a “D” shape or an “O” shape in other embodiments.

The Gripstay channel plug 100 is inserted into the Gripstay channel lumen 120 by one of several methods. Firstly, the Gripstay channel plug 100 may be slidingly inserted into the lumen 120. Secondly, the Gripstay channel plug 100 may be snappingly inserted into the Gripstay channel lumen 120. Thirdly, the Gripstay channel plug 100 may be springingly inserted into the Gripstay channel lumen 120. Fourthly, the Gripstay channel plug 100 may be inserted into the Gripstay channel lumen 120 by twisting and/or adjusting the immovable ends 310, 320 of the Gripstay channel plug to sit within the Gripstay channel lumen 120. Fifthly, the Gripstay channel plug 100 may be ratchetingly inserted into the Gripstay channel lumen 120. Once inserted, the Gripstay channel plug 100 substantially covers the Gripstay channel lumen 120 sufficient to prevent SFRM 160 from entering the Gripstay channel lumen 120 during application of the SFRM 160 to the steel beam 180 to which the Gripstay channel 140 is immovably affixed, generally by welding. The method of affixment of the Gripstay channel 140 to the steel beam 180 is immaterial to and outside of the scope of the present invention.

The Gripstay channel plug 100 may be made of any material capable of blocking the entrance of SFRM 160 into the Gripstay channel lumen. Such materials include but are not limited to flexible plastics, inflexible plastics, flexible rubbers, inflexible rubbers, wood, metal, ceramics, epoxies, polymers, laminates, silicones, glasses, cork, fiberglass, carbon fibers, plastic, metal, rubber, polyvinyl choloride (PVC), graphite, acetyl, acrylic, acrylonitrile-butadiene-styrene (ABS), alkyd resins, butadiene, cellulose, cellulose acetate, engineered plastics, epoxy resins, fluoroplastics, foam plastics, foam rubber, furane, isoprene, latex, nylon, phenolic resins, phenylene oxide, polyacetal, polycarbonate, polyester, polyethylene, polyimide, polyphenylene oxide, polypropylene, polystyrene, polysulfone, polyurethanes, silicone, silicone resins, styrene, thermoplastics, thermosets, urethanes, vinyl chloride, alumina, aluminosilicates, carbides, concrete, glass, granite, magnesia, marble, mica, mullite, nitrides, oxide ceramics, plaster, quartz, silica, spinel, talc, zircon, or any combination thereof. Other materials capable of blocking SFRM 160 from entering the Gripstay channel lumen 120 that not listed are within the scope of the present invention.

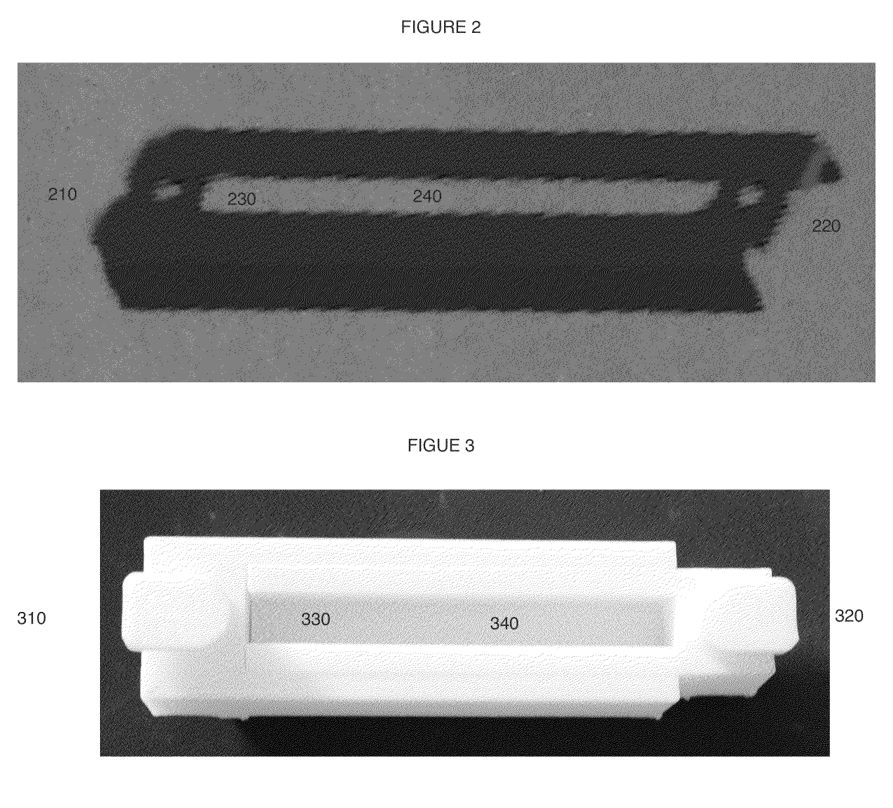

Referring now to FIG. 2, a Gripstay plug channel lumen 230 is shown. A first end 210 and a second end 220 of the Gripstay plug channel lumen 230 are each narrower than is the central portion 240 of the Gripstay plug channel lumen 230.

Referring now to FIG. 3, a Gripstay channel plug 100 is shown with a first end 310 and a second end 320 of the Gripstay channel plug 100 being narrower than is the central portion 330 of the Gripstay channel plug 100. A first 340 and second 350 catch, used to anchor the Gripstay channel plug 100 in the Gripstay channel, may be present on the Gripstay channel plug 100. A first 360 and second 370 push/pull tab may be present on each of the Gripstay channel plug ends 310/320.

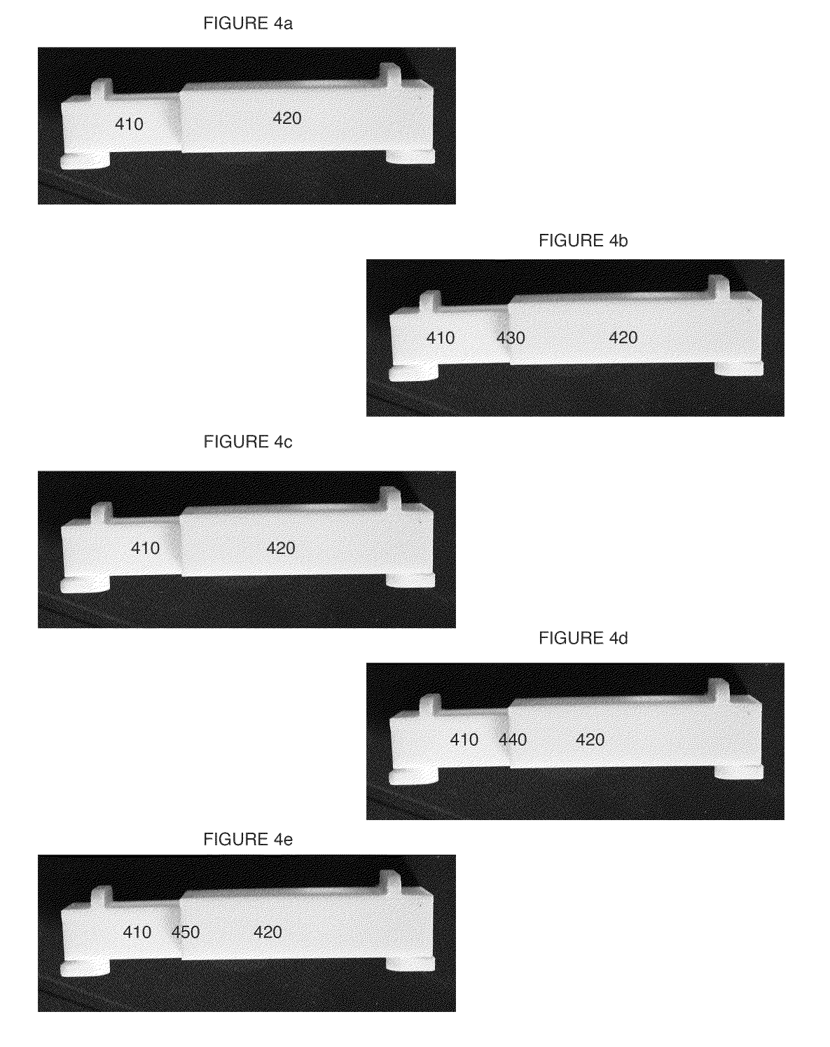

Referring now to FIG. 4a, a Gripstay channel plug 100 is shown with two Gripstay channel plug ends 310/320 slidingly attached together. A first Gripstay plug piece 410 fits within a second Gripstay plug piece 420 such that the two pieces 410 and 420 slide together to permit the two Gripstay plug ends 310/320 to be set at a particular distance apart such that the Gripstay plug 100 substantially covers a Gripstay channel lumen 120, preventing SFRM 160 from entering the Gripstay channel lumen 120.

Referring now to FIG. 4b, a Gripstay channel plug 100 is shown with a first end 310 affixed to a second end 320 through a snapping connection 430. The two pieces 410 and 420 snap together to permit the two Gripstay plug ends 310 and 320 to be set at a particular distance apart such that the Gripstay channel plug 100 substantially covers a Gripstay channel lumen 120, preventing SFRM 160 from entering the Gripstay channel lumen 120.

Referring now to FIG. 4c, a Gripstay channel plug 100 is shown with two Gripstay channel plug ends 310/320 immovably attached to the Gripstay channel plug body 100. The Gripstay channel plug 100 is molded, cast, welded, or otherwise affixed such that the two ends 310/320 are at a fixed distance from one another allowing the Gripstay channel plug 100 to fit within and substantially cover the Gripstay channel lumen 120, preventing SFRM 160 from entering the Gripstay channel lumen 120.

Referring now to FIG. 4d, a Gripstay channel plug 100 is shown with a first end 310 affixed to a second end 320 through a spring 440. The two Gripstay plug piece ends 410 and 420 are held together with a spring 440 to permit the two Gripstay channel plug ends 310 and 320 to be set at a particular distance apart such that the Gripstay channel plug 100 substantially covers a Gripstay channel lumen 120, preventing SFRM 160 from entering the Gripstay channel lumen 120.

Referring now to FIG. 4e, a Gripstay channel plug 100 is shown with a first end 310 affixed to a second end 320 through a ratchet connection 450. The two Gripstay plug pieces 410 and 420 ratchet together to permit the two Gripstay channel plug ends 310 and 320 to be set at a particular distance apart such that the Gripstay channel plug 100 substantially covers a Gripstay channel lumen 120, preventing SFRM 160 from entering the Gripstay channel lumen 120.

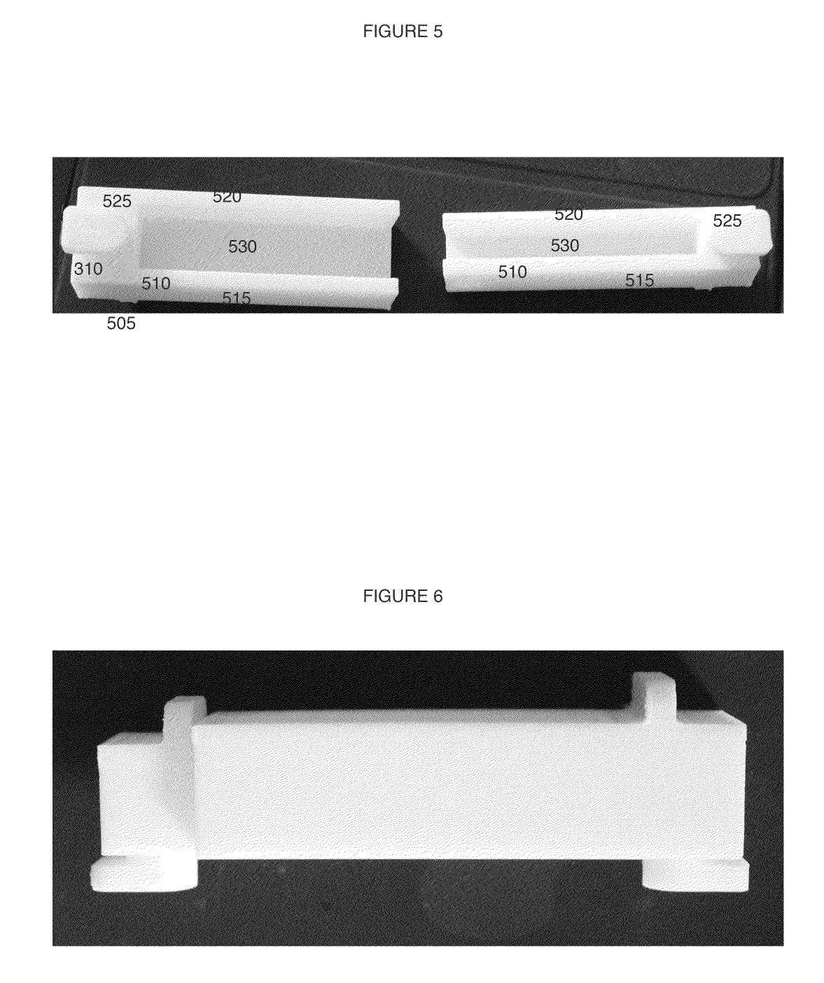

Referring now to FIG. 5, an exploded view of a Gripstay channel plug 100 is shown. The Gripstay channel plug 100 comprises a top side 505, a bottom side 510, a left side 515, a right side 520, a face side 525, a back side 530, a first end 310, a second end 320, a central portion 330. The entirety of the Gripstay channel plug 100 is designed to substantially cover the Gripstay channel lumen 120

Referring now to FIG. 6, a Gripstay channel plug 100 is shown inserted into a Gripstay channel 140.

### DESCRIPTION OF USE

The present invention, when inserted into a Gripstay channel lumen 120 and expanded to hold the Gripstay channel plug 100 in place, provides protection over the lumen 120. The present invention 100 keeps the lumen 120 free of unwanted SFRM 160 while allowing for required SFRM 160 coverage.

The Gripstay channel plug 100, in its present embodiment, is molded in a “C” shape, but may be molded into a “D” shape or an “O” shape in other embodiments. One piece may slide inside the other using push/pull tabs 360/370 in the present embodiment; a spring 440 or a ratchet connection 450 may be substituted for or used to supplement push/pull tabs 360/370, or the mechanism may be one in which the ends 310/320 are immobile, in other embodiments.

In the present embodiment, the pieces are configured with the second Gripstay plug piece 420, fitting inside the first Gripstay plug piece 410, having a slight “V” taper molded on its outside slightly smaller to match a “V” taper molded on the inside of the first Gripstay plug piece 410. This tapering acts as a dovetail that allows the Gripstay plug pieces 410/420 to slide together or pull apart using the push/pull tabs 360/370 located on each piece. The pieces, in an alternate embodiment, may slide together using a tongue-in-groove configuration.

The invention is anchored to the inside of the slot in the Gripstay with two catches 340/350, one at either end of the Gripstay channel plug 100, which are used to hold the invention in place in the Gripstay lumen 120. The catches 340/350 are, in the present embodiment, configured in an “L” shape which catches on either end of the Gripstay lumen 120. The catches 340/350 slide under the Gripstay lumen apices 540, holding the Gripstay channel plug 100 in place. The invention protects the Gripstay lumen 120 from unwanted SFRM 160 covering the lumen 120 while allowing the complete coverage of SFRM 160 to the surrounding surfaces. Since the Gripstay channel plug 100 is adjustable, it can accommodate various Gripstay lumen 120 lengths.

The top side 505 may be molded such that removing the plug from the Gripstay channel lumen 120 after application of SFRM 160 does not signficantly disrupt the layer of SFRM 160.

To use the invention, the user grasps push/pull tabs 360/370 and pulls or pushes the tabs 360/370 until the Gripstay channel plug 100 length is appropriate to insert the invention into the Gripstay lumen 120. In another embodiment, the push/pull tabs might be replaced or supplemented by a spring 440 or ratchet connection 450. The user then places the Gripstay channel plug 100 firmly on the Gripstay lumen 120 and pushes the push/pull tabs 360/370 (or expands the spring 440 or ratchet connection 450) to lengthen the Gripstay channel plug 100 until the Gripstay channel plug catches 340/350 fully seat under the Gripstay channel lumen apices 540. To remove the device after SFRM 160 has been applied, the user grasps the push/pull tabs 360/370 (or, in other embodiments, loosens the spring or uses the ratcheting mechanism) and pulls the Gripstay plug ends 310/320 together, shortening the Gripstay channel plug 100 until the catches 340/350 clear the Gripstay lumen apices 540, then lifts the device straight off the Gripstay (not pictured).

This process leaves the Gripstay channel lumen 120 free of any SFRM 160 buildup, ready to hold inserted anchors/accessories needed. Additionally, the damage to the SFRM 160 is significantly reduced, requiring far less time to patch the SFRM 160 than is currently required with the manual cleaning of the Grupstay channel lumen 120 that is the current state of the art. Furthermore, the time, labor and expense previously required to remove the SFRM 160 from the Gripstay channel lumen 120 are eliminated or significantly reduced by the use of the present invention.

There currently exists a need in the industry for a device and associated method that protect the slot of the Gripstay from SFRM 160 while allowing the surrounding Gripstay (not pictured) and steel beam 180 to be coated.

The Gripstay channel plug 100 allows the Gripstay channel lumen 120 to remain clean and clear of any SFRM 160. The present invention can be inserted and removed quickly. Furthermore, the present invention can be adjusted to various lengths. Still further, the present invention protects the Gripstay channel lumen 120 but allows the surrounding area to be coated. The invention adjusts to various lengths; it is easily attached and removed without damage to the SFRM 160, and it greatly reduces the time/labor and materials used to repair the SFRM 160 using the current manual removal process.

The Gripstay channel plug 100 may be held at the appropriate length by friction, by a spring mechanism, or by a ratchet mechanism, or it may be immovable at a fixed length.

In a preferred embodiment, the Gripstay channel plug 100 has two narrowed ends 310/320. However, in an alternate embodiment, the narrowed ends may be narrowed more or less than shown in FIGS. 1-6, or may not be narrowed.

In a preferred embodiment, the Gripstay channel plug 100 fits inside of the Gripstay channel lumen 120. In an alternate embodiment, the Gripstay channel plug 100 may sit outside of the Gripstay channel lumen 120, adhering to the Gripstay channel 140 through a means such as suction or weak glue.

In a preferred embodiment, the Gripstay channel plug 100 has two ends 310/320 that are slidingly adjustable. In an alternate embodiment, the Gripstay channel plug 100 has two ends 310/320 that are adjustable by another means, such as snappingly, ratchetingly, or springingly. In yet another alternate embodiment, the Gripstay channel plug 100 may have ends 310/320 that are immovable.

The embodiments provided here are examples only and are not intended to be a complete listing of possible embodiments, nor should they be construed as an exclusive listing of embodiments. Variations in the described invention and its uses are possible within the scope of this disclosure without departing from the subject matter coming within the scope of claims to be examined, and a reasonable equivalency thereof, which I regard as our invention.

We claim:

1. A Gripstay channel plug for use in covering a Gripstay channel lumen contained in a Gripstay channel during the application of SFRM as part of the construction of steel-frame buildings, said plug comprising:
a top side;
a bottom side;
a left side;
a right side;
a face side; and
a first end that is affixed to a second end such that said plug substantially covers said Gripstay channel lumen to substantially prevent said SFRM from entering said lumen.

2. The plug of claim 1 wherein the affixment type of the first end to the second end is selected from the group consisting of slidingly affixed, springingly affixed, snappingly affixed, ratchetingly affixed, and immovably affixed.

3. The plug of claim 1 wherein the top side is molded to enable a user to remove said plug from the Gripstay channel lumen without signficantly disrupting an applied layer of SFRM.

4. The plug of claim 1 wherein said bottom side mold comprises a base portion and a catch protruding to said first end as to be under said Gripstay channel, securing said plug at the apex of said Gripstay channel lumen when said plug second end is affixed to said second end through a midsection that can be expanded or retracted.

5. The plug of claim 4 wherein the means of expanding or retracting said midsection is selected from the group consisting of push/pull tabs, ratchet mechanism, and spring mechanism.

6. The plug of claim 1 wherein said plug is made of a combination of materials selected from the group consisting of flexible plastics, inflexible plastics, flexible rubbers, inflexible rubbers, wood, metal, ceramics, epoxies, polymers, laminates, silicones, glasses, cork, fiberglass, carbon fibers, plastic, metal, rubber, polyvinyl choloride (PVC), graphite, acetyl, acrylic, acrylonitrile-butadiene-styrene (ABS), alkyd resins, butadiene, cellulose, cellulose acetate, engineered plastics, epoxy resins, fluoroplastics, foam plastics, foam rubber, furane, isoprene, latex, nylon, phenolic resins, phenylene oxide, polyacetal, polycarbonate, polyester, polyethylene, polyimide, polyphenylene oxide, polypropylene, polystyrene, polysulfone, polyurethanes, silicone, silicone resins, styrene, thermoplastics, thermosets, urethanes, vinyl chloride, alumina, aluminosilicates, carbides, concrete, glass, granite, magnesia, marble, mica, mullite, nitrides, oxide ceramics, plaster, quartz, silica, spinel, talc, and zircon.

7. A plug for use in covering a Gripstay channel lumen during the application of SFRM as part of the construction of steel-frame buildings, said plug comprising:
a face side;
a top side;
a bottom side;
a left side;
a right side; and
a first end that is affixed to a second end, wherein said affixment is chosen from a member of the group consisting of slidingly affixed, springingly affixed, snappingly affixed, ratchetingly affixed, and immovably affixed;
said plug being made from a combination of materials selected from the group consisting of flexible plastics, inflexible plastics, flexible rubbers, inflexible rubbers, wood, metal, ceramics, epoxies, polymers, laminates, silicones, glasses, cork, fiberglass, carbon fibers, plastic, metal, rubber, polyvinyl choloride (PVC), graphite, acetyl, acrylic, acrylonitrile-butadiene-styrene (ABS), alkyd resins, butadiene, cellulose, cellulose acetate, engineered plastics, epoxy resins, fluoroplastics, foam plastics, foam rubber, furane, isoprene, latex, nylon, phenolic resins, phenylene oxide, polyacetal, polycarbonate, polyester, polyethylene, polyimide, polyphenylene oxide, polypropylene, polystyrene, polysulfone, polyurethanes, silicone, silicone resins, styrene, thermoplastics, thermosets, urethanes, vinyl chloride, alumina, aluminosilicates, carbides, concrete, glass, granite, magnesia, marble, mica, mullite, nitrides, oxide ceramics, plaster, quartz, silica, spinel, talc, and zircon;
such that said plug substantially covers said lumen to substantially prevent said SFRM from entering said lumen.

8. A method for use of a plug for use in covering a lumen contained in a Gripstay channel during the application of SFRM as part of the construction of steel-frame buildings, comprising
grasping push/pull tabs
pulling or pushing said tabs until said Gripstay channel plug length is appropriate to insert the device into said lumen;
placing said Gripstay channel plug 100 firmly on the Gripstay lumen pushing said push/pull tabs to lengthen said Gripstay channel plug until the Gripstay channel plug catches fully seat under the Gripstay channel lumen apices 540
applying SFRM
grasping said push/pull tabs
pulling said Gripstay plug ends together, shortening the Gripstay channel plug 100 until the catches clear said Gripstay lumen apices lifting the device straight off the Gripstay.

9. The method of claim 8 wherein said push/pull tabs are used in conjunction with a spring mechanism.

10. The method of claim 10 wherein said push/pull tabs are used in conjunction with a ratcheting mechanism.
